(19) United States
(12) Patent Application Publication
(10) Pub. No.: US 2017/0154035 A1
(43) Pub. Date: Jun. 1, 2017

(54) TEXT PROCESSING SYSTEM, TEXT PROCESSING METHOD, AND TEXT PROCESSING PROGRAM

(71) Applicant: NEC Corporation, Tokyo (JP)

(72) Inventors: Takashi ONISHI, Tokyo (JP); Masaaki TSUCHIDA, Tokyo (JP); Kosuke YAMAMOTO, Tokyo (JP); Hironori MIZUGUCHI, Tokyo (JP); Kai ISHIKAWA, Tokyo (JP)

(21) Appl. No.: 15/327,614

(22) PCT Filed: Jun. 26, 2015
(86) PCT No.: PCT/JP2015/003222

§ 371 Date: Jan. 19, 2017

(30) Foreign Application Priority Data
Jul. 23, 2014 (JP) 2014-149424

(51) Int. Cl. G06F 17/27; G06F 17/30; G06F 17/21

(52) U.S. Cl. CPC G06F 17/2775; G06F 17/21; G06F 17/30675; G06F 17/3071

(57) ABSTRACT

Provided is a text processing system which, when an attribute corresponding to one tabulation axis is set, is capable of generating a text group which will produce non-obvious tabulation results when cross-tabulation is performed using that attribute. At the time of input of respective attribute values of an attribute which corresponds to a tabulation axis in cross tabulation and a document associated with any one of the attribute values of the attribute, text extraction means 71 extracts portion not including the attribute value of the attribute from each text obtained by dividing the document into predetermined units. Group generation means 72 performs entailment recognition between texts on the extracted texts and groups texts having an entailment relation.

### TECHNICAL FIELD

The present invention relates to a text processing system, a text processing method, and a text processing program for performing text extraction and group generation.

### BACKGROUND ART

A call center receives opinions such as complaints or objections on various products or services from customers. Moreover, companies collect customers' opinions on products or services by questionnaires It is important for the companies to improve services on the basis of the customers' opinions or to apply the opinions in product development.

Non Patent Literature (NPL) 1 describes a method of mapping two categories along two axes and tabulating texts for each combination of items in the two categories. Thus, useful findings can be derived by reference to correlation between the categories.

Moreover, Patent Literature (PTL) 1 describes a method in which a synonymous relation or an entailment relation between texts is determined and texts having the same meaning are clustered when texts written in the natural language are automatically tabulated, so that the texts are tabulated in a manner in which the contents of the texts can be directly understood.

One type of processing on texts is entailment recognition. The entailment recognition is processing of determining whether or not the relation “A entails B” is present, where “A” and “B” are texts. Moreover, the term “A entails B” means that if A is true then B is true. Hereinafter, a relation that one text entails the other text will be referred to as “entailment relation” in some cases. An example of the entailment recognition is described in Non Patent Literature (NPL) 2.

In addition, a process of associating two attributes with two axes and performing a tabulation for each combination of attribute values of the two attributes is referred to as “cross tabulation.” FIG. 4 in NPL 1 illustrates an example of a result of the cross tabulation. In cross tabulation, an axis with which an attribute is associated is referred to as “tabulation axis.”

### CITATION LIST

### Patent Literature

PTL 1: International Publication No. WO 2013/161850

### Non Patent Literature

NPL 1: Tetsuya Nasukawa, “Text Mining Application for Call Centers,” The Japanese Society for Artificial Intelligence, Journal of Japanese Society for Artificial Intelligence Vol. 16 No. 2, pp. 219-215, Mar. 1, 2001

NPL 2: Masaaki Tsuchida, Kai Ishikawa, “IKOMA at TAC2011: A Method for Recognizing Textual Entailment using Lexical-level and Sentence Structure-level features,” [online], [searched for on Jul. 10, 2014], Internet<URL: http://www.nist.gov/tac/publications/2011/participant.papers/IKOMA.proceedings.pdf>

### SUMMARY OF INVENTION

### Technical Problem

As described above, it is important for a company to improve services on the basis of customers' opinions or to apply the opinions in product development. The opinions, however, are written in the natural language and not structured. Therefore, it is difficult to obtain useful findings wholly from the opinions.

According to the technique described in NPL 1, useful findings can be derived by reference to the correlation between categories in a tabulation result. In the technique described in NPL 1, however, it is necessary to previously define respective items of the two categories depending on from which viewpoint an analysis is performed. Therefore, findings based on a new viewpoint cannot be obtained. Furthermore, it seems appropriate to define a category as a document set including a specific word or modification to perform cross tabulation. Even if words and modifications are expressed on the tabulation axis, however, readability is low and it is difficult to obtain new findings from such a tabulation result.

Moreover, according to the technique described in PTL 1, a cluster of texts whose contents are easily understood is acquired. Even if cross tabulation is to be performed by using the cluster and other attributes, however, useful findings are hard to obtain from a cross tabulation result in the case of a strong dependence relation between the attribute values of the attributes and individual clusters. An example thereof will be described below.

FIG. 11 is a schematic diagram illustrating an example of a result of clustering texts having the same meaning after determining a synonymous relation or an entailment relation between texts. Each cluster illustrated in FIG. 11 includes a text having the same meaning as a representative text. Therefore, in the example illustrated in FIG. 11, a cluster 1 includes a text which is similar to a text “commodity A is expensive.” Therefore, the cluster 1 includes a text related to commodity A but does not include a text related to any other commodities such as “commodity B is expensive.” Similarly, a cluster 2 includes a text related to commodity B but does not include a text related to any of commodities other than commodity B. A cluster 3 includes a text related to a commodity C but does not include a text related to any of commodities other than the commodity C. Specifically, the type of a commodity has a strong dependence relation with a cluster.

In this case, if cross tabulation is performed by tabulating texts for each cluster with a commodity associated with one tabulation axis, a result thereof is as illustrated in FIG. 12. Since one cluster is a set of texts including a common commodity name, an only obvious result (the same contents as those illustrated in FIG. 11) can be obtained as illustrated in FIG. 12 even if cross tabulation is performed for the cluster illustrated in FIG. 11 with the commodities associated with tabulation axes. Accordingly, even if cross tabulation is performed, new findings cannot be obtained.

Therefore, it is an object of the present invention to provide a text processing system, a text processing method, and a text processing program capable of generating a text group which will produce non-obvious tabulation results when cross tabulation is performed using an attribute corresponding to one tabulation axis in the case of setting the attribute.

### Solution to Problem

According to the present invention, there is provided a text processing system including: text extraction means for extracting portions not including attribute values of an attribute from each text obtained by dividing a document into predetermined units at the time of input of respective attribute values of the attribute which corresponds to a tabulation axis in cross tabulation and a document associated with any one of the attribute values of the attribute; and group generation means for performing entailment recognition between texts on the extracted texts and grouping texts having an entailment relation.

Furthermore, according to the present invention, there is provided a text processing system including: text extraction means for extracting texts obtained by dividing a document into predetermined units at the time of input of respective attribute values of an attribute which corresponds to a tabulation axis in cross tabulation and a document associated with any one of the attribute values of the attribute; and group generation means for performing entailment recognition between texts on the extracted texts while ignoring the attribute value among wordings in the extracted text and grouping texts having an entailment relation.

Furthermore, according to the present invention, there is provided a text processing method including: extracting portions not including attribute values of an attribute from each text obtained by dividing a document into predetermined units at the time of input of respective attribute values of the attribute which corresponds to a tabulation axis in cross tabulation and a document associated with any one of the attribute values of the attribute; and performing entailment recognition between texts on the extracted texts and grouping texts having an entailment relation.

Furthermore, according to the present invention, there is provided a text processing method including: extracting texts obtained by dividing a document into predetermined units at the time of input of respective attribute values of an attribute which corresponds to a tabulation axis in cross tabulation and a document associated with any one of the attribute values of the attribute; and performing entailment recognition between texts on the extracted texts while ignoring the attribute value among wordings in the extracted text and grouping texts having an entailment relation.

Furthermore, according to the present invention, there is provided a text processing program causing a computer to perform: text extraction processing of extracting portions not including attribute values of an attribute from each text obtained by dividing a document into predetermined units at the time of input of respective attribute values of the attribute which corresponds to a tabulation axis in cross tabulation and a document associated with any one of the attribute values of the attribute; and group generation processing of performing entailment recognition between texts on the extracted texts and grouping texts having an entailment relation.

Furthermore, according to the present invention, there is provided a text processing program causing a computer to perform: text extraction processing of extracting texts obtained by dividing a document into predetermined units at the time of input of respective attribute values of an attribute which corresponds to a tabulation axis in cross tabulation and a document associated with any one of the attribute values of the attribute; and group generation processing of performing entailment recognition between texts on the extracted texts while ignoring the attribute value among wordings in the extracted text and grouping texts having an entailment relation.

### Advantageous Effects of Invention

According to the present invention, in the case of setting an attribute corresponding to one tabulation axis, it is possible to generate a text group which will produce non-obvious tabulation results when cross tabulation is performed using the attribute.

### BRIEF DESCRIPTION OF DRAWINGS

FIG. 1 is a block diagram illustrating an example of a text processing system according to a first exemplary embodiment of the present invention.

FIG. 2 is a flowchart illustrating an example of the progress of processing according to the first exemplary embodiment of the present invention.

FIG. 3 is a schematic diagram illustrating an example of a cross tabulation table output in step S5.

FIG. 4 is a schematic diagram illustrating an example of a cross tabulation result in the case where multiple types of attributes corresponding to one tabulation axis are present.

FIG. 5 is a block diagram illustrating an example of a text processing system according to a second exemplary embodiment of the present invention.

FIG. 6 is a block diagram illustrating an example of a more concrete configuration of the text processing system according to the second exemplary embodiment of the present invention.

FIG. 7 is a flowchart illustrating an example of the progress of processing according to the second exemplary embodiment of the present invention.

FIG. 8 is a schematic block diagram illustrating a configuration example of a computer according to the respective exemplary embodiments of the present invention.

FIG. 9 is a block diagram illustrating an example of the minimum configuration of the text processing system of the present invention.

FIG. 10 is a block diagram illustrating another example of the minimum configuration of the text processing system of the present invention.

FIG. 11 is a schematic diagram illustrating an example of a result of determining a synonymous relation or an entailment relation between texts and clustering texts having the same meaning.

FIG. 12 is a schematic diagram illustrating a result of performing cross tabulation for the clusters illustrated in FIG. 11.

### DESCRIPTION OF EMBODIMENT

Hereinafter, the exemplary embodiments of the present invention will be described with reference to accompanying drawings.

### Exemplary Embodiment 1

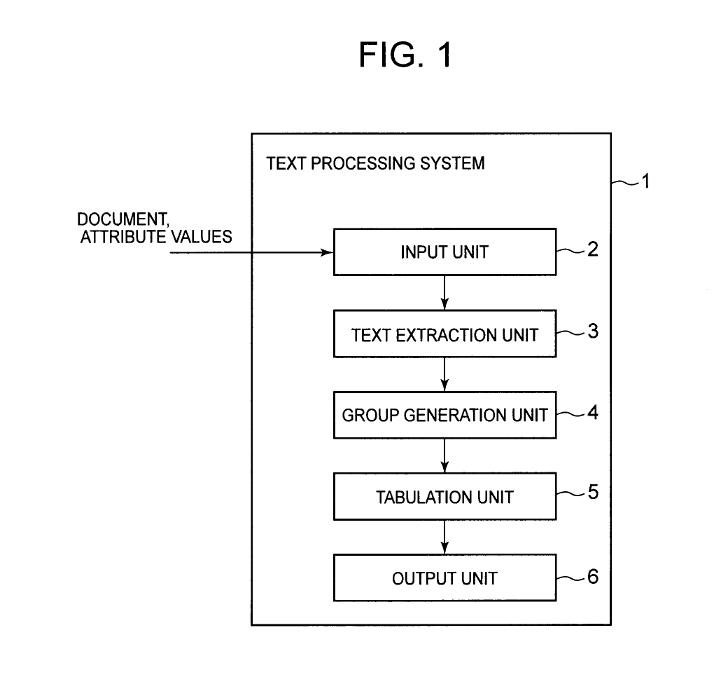

FIG. 1 is a block diagram illustrating an example of a text processing system according to a first exemplary embodiment of the present invention. The text processing system 1 of the first exemplary embodiment includes an input unit 2, a text extraction unit 3, a group generation unit 4, a tabulation unit 5, and an output unit 6.

The input unit 2 is an input interface for accepting an input of a document and attribute values of the attribute corresponding to one tabulation axis in cross tabulation. The input document is not limited to one, but a plurality of documents may be input. Moreover, the input unit 2 may accept an input of other parameters.

The text processing system 1 of this exemplary embodiment generates a group of texts as described later. The text processing system 1 then performs cross tabulation by tabulating texts corresponding to respective attribute values for each group. The term “respective attribute values of an attribute corresponding to one tabulation axis in cross tabulation” falls under the term of these respective attribute values. Assuming that an attribute corresponding to one tabulation axis is “commodity,” various commodity names are input as attribute values into the input unit 2, for example. Hereinafter, the attributes values of the attribute corresponding to one tabulation axis in cross tabulation will be referred to as “attribute values used for cross tabulation” in some cases.

Moreover, any one of the attribute values used for cross tabulation is associated with an individual document input to the input unit 2. Information on the corresponding attribute value is appended to the individual document.

The following description will be made by giving an example in which preprocessing has already been performed on each document so that an individual document includes only texts representing a specific content. For example, it is assumed that all of the individual documents are subjected to preprocessing so as to include only a text representing a customer complaint. Although the above example illustrates a customer complaint as a specific content, the specific content may be any other content. The preprocessing enables texts falling under the specific content to be grouped.

The text extraction unit 3 divides each input document into predetermined units. For example, the text extraction unit 3 divides each input document into sentence units. The units into which the text extraction unit 3 divides each document, however, are not limited to sentence units.

Furthermore, the text extraction unit 3 extracts a portion not including the attribute value used for cross tabulation from each text obtained by dividing the document. The following describes an example of processing in which the text extraction unit 3 extracts the portion not including the attribute value from each text.

The text extraction unit 3 may extract a portion obtained by excluding a phrase including an attribute value used for cross tabulation from each text obtained by dividing the document. For example, the attribute values used for cross tabulation are assumed to be “commodity A,” “commodity B,” and the like. Then, if a text “commodity A is expensive” is obtained, for example, the text extraction unit 3 extracts a portion “expensive.”

Moreover, it is assumed that the text extraction unit 3 divides each input document into sentence units. In this case, the text extraction unit 3 may extract only a predicate from each text obtained by dividing the document into sentence units. The attribute value used for cross tabulation tends to appear in the subject of a sentence. Therefore, the text extraction unit 3 is able to extract a portion not including the attribute value used for cross tabulation by extracting only the predicate from each text obtained by dividing the document into sentence units.

When extracting a text not including the attribute value used for cross tabulation, the text extraction unit 3 causes the extracted text to inherit the attribute value having been associated with the extraction source document of the text. Specifically, the text extraction unit 3 associates the same attribute value as one having been associated with the extraction source document with the extracted text.

The group generation unit 4 performs entailment recognition between texts on individual texts extracted by the text extraction unit 3. The entailment recognition method is not particularly limited. For example, the group generation unit 4 may perform the entailment recognition between texts by using the method described in NPL 2. The group generation unit 4 then groups texts having an entailment relation. In other words, the group generation unit 4 generates a group of texts so that the texts having an entailment relation belong to the same group. For example, the group generation unit 4 may select the texts extracted by the text extraction unit 3 one by one and may generate a group having texts entailing the selected text as members. Hereinafter, the selected text is referred to as a representative text in some cases. The above group generation method is only illustrative and the group generation unit 4 may generate a group of texts by using any other method.

The group generation unit 4 can also be referred to as “clustering unit” and the generated individual group can also be referred to as “cluster.”

The tabulation unit 5 tabulates texts corresponding to each attribute value used for cross tabulation (each attribute value input to the input unit 2) for each group generated by the group generation unit 4. For example, it is assumed that each attribute value used for cross tabulation is “commodity A,” “commodity B,” or the like. The tabulation unit 5 tabulates the number of texts associated with the attribute value “commodity A,” the number of texts associated with the attribute value “commodity B,” and the like with respect to each attribute value starting from the texts in the first group. The tabulation unit 5 performs the same processing with respect to each of the second and subsequent groups. Although the description has been made in this exemplary embodiment by giving an example of tabulating the number of texts, the tabulation unit 5 may tabulate the ratio of the number of texts associated with the attribute value “commodity A” to the number of texts in a group or the like with respect to each attribute value.

It can be said that the tabulation unit 5 performs cross tabulation assuming that the input attribute value corresponds to one tabulation axis and each group corresponds to the other tabulation axis.

The output unit 6 outputs a cross tabulation table showing a cross tabulation result obtained by the tabulation unit 5. For example, the output unit 6 causes a display device (not illustrated in FIG. 1) to display the cross tabulation table.

The text extraction unit 3, the group generation unit 4, the tabulation unit 5, and the output unit 6 are implemented by the CPU of a computer which operates according to the text processing program, for example. In this case, the CPU may read the text processing program from a program recording medium such as, for example, a program storage device (not illustrated in FIG. 1) of the computer and then operate as the text extraction unit 3, the group generation unit 4, the tabulation unit 5, and the output unit 6 according to the text processing program. Furthermore, the text extraction unit 3, the group generation unit 4, the tabulation unit 5, and the output unit 6 may be implemented by different pieces of hardware.

The text processing system may have a configuration in which two or more physically-separated devices are wired or wirelessly connected to each other. The same applies to the exemplary embodiments described later.

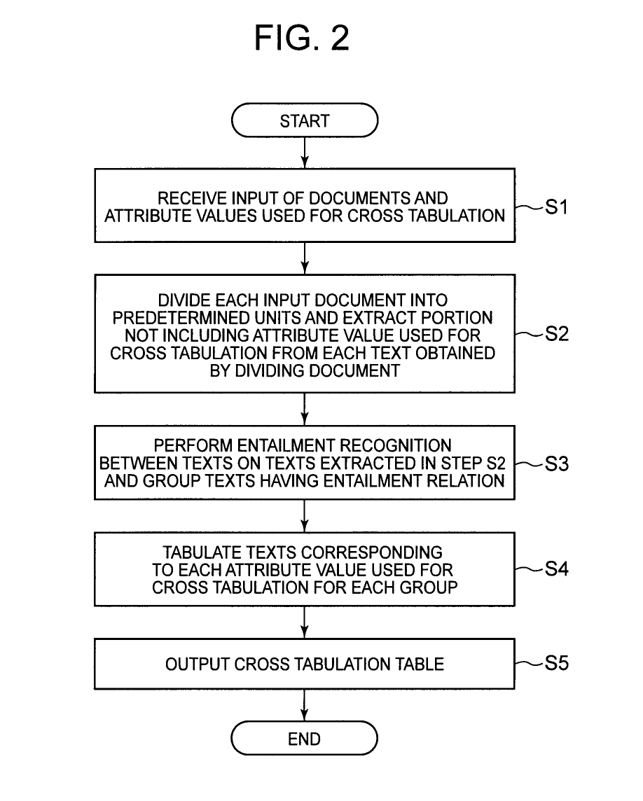

Subsequently, the progress of processing will be described. FIG. 2 is a flowchart illustrating an example of the progress of processing according to the first exemplary embodiment of the present invention. First, the input unit 2 receives an input of documents and attribute values used for cross tabulation (step S1). Each document input in step S1 includes only a text representing a specific content (for example, a customer complaint). Moreover, each document is associated with any one of attribute values used for cross tabulation and information on the corresponding attribute value is appended to the document.

The text extraction unit 3 divides each document into predetermined units (for example, into sentence units). The text extraction unit 3 then extracts a portion not including the attribute value used for cross tabulation from each text obtained as a result (step S2).

In step S2, the text extraction unit 3 may extract a portion obtained by excluding a phrase that includes the attribute value used for cross tabulation from each text obtained by dividing the document.

Alternatively, in step S2, the text extraction unit 3 may divide each document into sentence units and extract only a predicate from each text obtained as a result.

Moreover, in step S2, the text extraction unit 3 associates the same attribute value as one having been associated with the extraction source document with the extracted text.

Subsequently, the group generation unit 4 performs entailment recognition between texts on individual texts extracted in step S2. The group generation unit 4 then generates a group of texts so that the texts having an entailment relation belong to the same group (step S3).

Subsequently, the tabulation unit 5 tabulates texts corresponding to each attribute value (each attribute value input to the input unit 2) used for cross tabulation for each group generated in step S3 (step S4). It can be said that the tabulation unit 5 performs cross tabulation in step S4.

Subsequently, the output unit 6 outputs a cross tabulation table showing the tabulation results of step S4 (step S5). For example, the output unit 6 causes the display device to display the cross tabulation table.

In this exemplary embodiment, the text extraction unit 3 extracts texts each not including the attribute value used for cross tabulation (the attribute value input in step S1) in step S2. In step S3, the group generation unit 4 performs entailment recognition between texts on individual texts. Specifically, the group generation unit 4 performs entailment recognition between texts each not including the attribute value used for cross tabulation and generates a group of texts so that texts having an entailment relation are included in the same group. Therefore, there is no dependence relation between individual group and the attribute value used for cross tabulation. For example, it is assumed that each attribute value used for cross tabulation is “commodity A,” “commodity B,” or the like. One group may include a mix of a text associated with “commodity A,” a text associated with “commodity B,” and texts associated with various attribute values. Therefore, according to this exemplary embodiment, when an attribute corresponding to one tabulation axis is set, it is possible to generate a text group which will produce non-obvious tabulation results when cross tabulation is performed using the attribute.

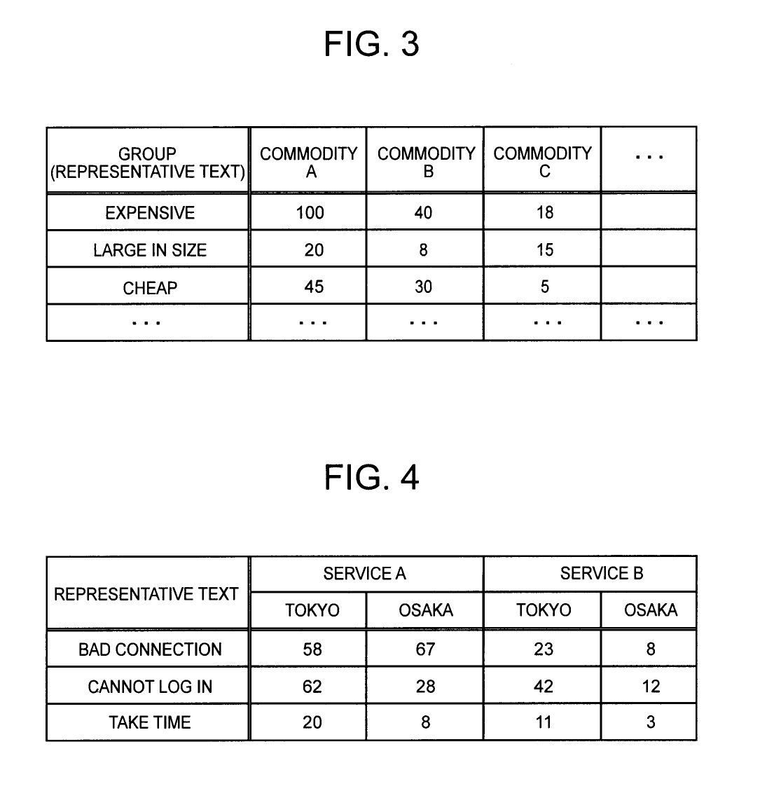

In this exemplary embodiment, the tabulation unit 5 tabulates texts corresponding to each attribute value used for cross tabulation for each group after the above group generation. Specifically, cross tabulation is performed. Then, the output unit 6 outputs a cross tabulation table. FIG. 3 is a schematic diagram illustrating an example of a cross tabulation table output in step S5. In the example illustrated in FIG. 3, a group is identified by a representative text. As described above, texts associated with various attribute values may be mixed in a group in this exemplary embodiment. Therefore, if an input attribute value is plotted along the axis of abscissa and a group is plotted along the axis of ordinate, significant tabulation results of texts corresponding to the respective attribute values are obtained in each group as illustrated in FIG. 3. Comparing this example with the example illustrated in FIG. 12, all texts in one group correspond to a common attribute value in the example illustrated in FIG. 12. Accordingly, the number of texts in one group is obtained as a tabulation result related to one attribute value and there is no tabulation result with respect to other attribute values. Therefore, it cannot be said that significant tabulation results are obtained. On the other hand, in the example illustrated in FIG. 3, significant tabulation results of texts corresponding to each attribute values are obtained in each group as described above. Therefore, new findings are obtained from the tabulation results. For example, in the example illustrated in FIG. 3, a fact that a text “cheap” appears relatively frequently with respect to commodity B, a fact that a text “large in size” appears relatively frequently with respect to the commodity C, and the like are obtained as new findings.

In the above exemplary embodiments, description has been made by giving an example in which preprocessing has already been performed on each document in advance so that an individual document includes only texts representing a specific content (for example, a customer complaint). The document input in step Si may be a document on which such preprocessing has not been performed. In this case, preferably the text extraction unit 3 extracts only texts corresponding to any of predetermined specific contents. For example, when dividing each input document into predetermined units and extracting a portion not including the attribute values used for cross tabulation from each text obtained as a result, preferably the text extraction unit 3 extracts the portion under the condition that the portion includes a wording representing the specific content. In the case of extracting a text representing “customer complaint,” an operator previously specifies keywords falling under complaints such as “expensive” and like. Thereafter, when extracting a portion not including the attribute values used for cross tabulation from each text, the text extraction unit 3 extracts the portion under the condition that the portion includes a specified keyword. Moreover, the text extraction unit 3 may extract only texts falling under the specific content in a method described below. The text extraction unit 3 may learn a discriminant model for discriminating whether or not a complaint is written by machine learning in advance. Moreover, when extracting the portion not including the attribute values used for cross tabulation from each text, the text extraction unit 3 may extract the portion under the condition that the portion matches the discriminant model. According to this configuration, texts can be grouped for texts falling under the specific content without performing the aforementioned preprocessing.

Although the description has been made by giving an example that one type of attribute corresponds to one tabulation axis in the above example, multiple types of attributes corresponding to one tabulation axis may be present. FIG. 4 is a schematic diagram illustrating an example of a cross tabulation result in the case where multiple types of attributes corresponding to one tabulation axis are present. In FIG. 4, there is illustrated a case where two types of attributes, “service” and “area” are associated with one tabulation axis. In the example illustrated in FIG. 4, the attribute values of “service” are “service A” and “service B” and the attribute values of “area” are “Tokyo” and “Osaka.”

### Exemplary Embodiment 2

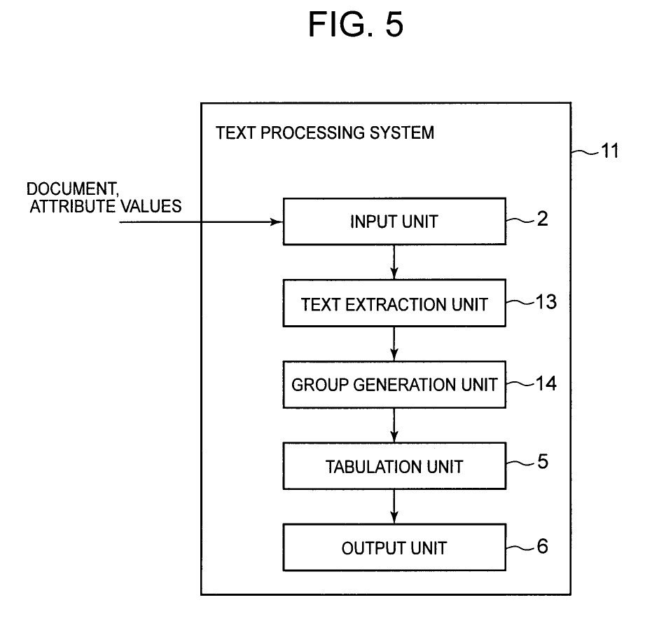

FIG. 5 is a block diagram illustrating an example of a text processing system according to a second exemplary embodiment of the present invention. The same reference numerals as those of FIG. 1 are used for the same elements as in the first exemplary embodiment and the description thereof is omitted here. A text processing system 11 of the second exemplary embodiment includes an input unit 2, a text extraction unit 13, a group generation unit 14, a tabulation unit 5, and an output unit 6.

The input unit 2, the tabulation unit 5, and the output unit 6 of the second exemplary embodiment are the same as the input unit 2, the tabulation unit 5, and the output unit 6 of the first exemplary embodiment.

Each document and each attribute value input to the input unit 2 are the same as each document and each attribute value input to the input unit 2 in the first exemplary embodiment. The input unit 2 may receive an input of other parameters. The following description will be made by giving an example in which preprocessing has already been performed on each document so that an individual document includes only texts representing the specific content. The preprocessing enables grouping of texts falling under the specific content.

The text extraction unit 13 extracts respective texts obtained by dividing each input text into predetermined units. For example, the text extraction unit 13 divides each document into sentence units and extracts respective texts. The units into which each document is divided by the text extraction unit 13, however, are not limited to sentence units. In the second exemplary embodiment, each text extracted by the text extraction unit 13 may include an attribute value used for cross tabulation (an attribute value input to the input unit 2).

When extracting individual texts, the text extraction unit 13 causes the extracted text to inherit the attribute value having been associated with the extraction source document of the text. Specifically, the text extraction unit 13 associates the same attribute value as one having been associated with the extraction source document with the extracted text.

The group generation unit 14 performs entailment recognition between texts on individual texts extracted by the text extraction unit 13. The entailment recognition method is not particularly limited. For example, the group generation unit 14 may perform entailment recognition between texts by using the method described in NPL 2. When performing the entailment recognition between extracted texts, however, the group generation unit 14 ignores a wording falling under the attribute value used for cross tabulation among the wordings in the texts in performing the entailment recognition.

For example, it is assumed that the attribute values used for cross tabulation are “commodity A,” “commodity B,” and the like. Moreover, it is assumed that texts “commodity A is expensive” and “commodity B is expensive” are included in the texts extracted by the text extraction unit 13. When performing the entailment recognition between these two texts, the group generation unit 14 ignores a wording “commodity A” in the former text and a wording “commodity B” in the latter text. As a result, the group generation unit 14 determines that the former entails the latter with respect to the two texts, “commodity A is expensive” and “commodity B is expensive” and that the latter entails the former. Although generally there is no entailment relation between the text “commodity A is expensive” and the text “commodity B is expensive,” the group generation unit 14 acquires a result that there is an entailment relation between the texts by ignoring the attribute values “commodity A” and “commodity B” in this exemplary embodiment.

The group generation unit 14 then groups the texts having an entailment relation. In other words, the group generation unit 14 generates a group of texts so that the texts having an entailment relation belong to the same group. For example, the group generation unit 14 may select the texts extracted by the text extraction unit 13 one by one and may generate a group having texts entailing the selected text as members. The above group generation method is only illustrative and the group generation unit 14 may generate a group of texts by using any other method. Similarly to the first exemplary embodiment, the text selected in the group generation is referred to as a representative text in some cases.

The group generation unit 14 may be also referred to as a clustering unit and each generated group may be also referred to as a cluster.

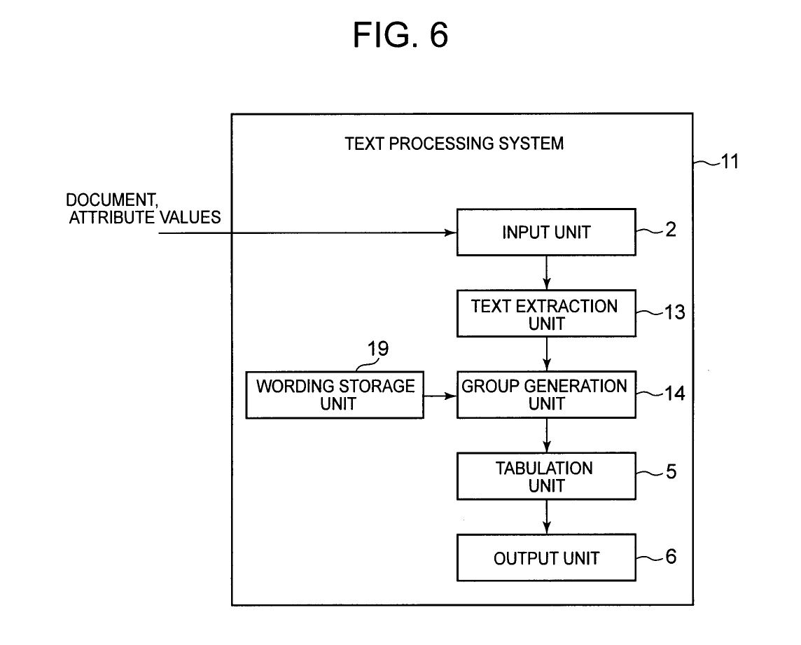

FIG. 6 is a block diagram illustrating an example of a more concrete configuration of the text processing system according to the second exemplary embodiment of the present invention. The same reference numerals as those of FIG. 5 are used for the same elements as those illustrated in FIG. 5 and the description thereof is omitted here. The text processing system 11 illustrated in FIG. 6 includes a wording storage unit 19 in addition to the elements illustrated in FIG. 5.

The wording storage unit 19 is a storage device which previously stores wordings to be ignored when the group generation unit 14 performs entailment recognition between texts. Specifically, each attribute value used for cross tabulation (each attribute value of an attribute corresponding to one tabulation axis in the cross tabulation) is previously stored as a wording to be ignored in the wording storage unit 19. The group generation unit 14 then may perform the entailment recognition while ignoring the wording stored in the wording storage unit 19 among wordings in the text when performing entailment recognition between texts extracted by the text extraction unit 13.

The wording stored in the wording storage unit 19 is a stop word and it can be said that the wording storage unit 19 stores a stop word dictionary.

The method of determining a wording to be ignored when the group generation unit 14 performs entailment recognition between texts is not limited to the method in which the wording storage unit 19 is used and may be any other method.

When performing entailment recognition between texts extracted by the text extraction unit 13 and if a stop word (a wording stored in the wording storage unit 19) is present in the texts, the group generation unit 14 may perform the entailment recognition assuming that the stop word is absent in the texts. Then, the group generation unit 14 may generate a group of texts after completing the entailment recognition between texts.

Moreover, when performing entailment recognition between texts extracted by the text extraction unit 13 and if a stop word (a wording stored in the wording storage unit 19) is present in the texts, the group generation unit 14 may perform the entailment recognition after replacing the stop word with an attribute name. Furthermore, the group generation unit 14 may generate a group of texts after completing the entailment recognition between texts. For example, it is assumed that the text subject to the entailment recognition is a text including an attribute value such as “commodity A is expensive,” “commodity B is expensive,” or the like. In this case, the group generation unit 14 replaces the attribute values “commodity A” and “commodity B” in the texts with an attribute name “commodity,” respectively, and converts each of the two illustrated texts to a text “commodity is expensive” to perform entailment recognition. Replacing an attribute value with an attribute name also enables entailment recognition with an attribute value ignored.

Moreover, when grouping texts, the group generation unit 14 deletes a phrase including an attribute value from the representative text of the group. Alternatively, the group generation unit 14 may replace the attribute value included in the representative text of the group with an attribute name.

In the second exemplary embodiment, the text extraction unit 13, the group generation unit 14, the tabulation unit 5, and the output unit 6 are implemented by, for example, the CPU of a computer operating according to the text processing program. In this case, the CPU may read the text processing program from a program recording medium such as, for example, a program storage device (not illustrated in FIGS. 5 and 6) of the computer and then operate as the text extraction unit 13, the group generation unit 14, the tabulation unit 5, and the output unit 6 according to the text processing program. Furthermore, the text extraction unit 13, the group generation unit 14, the tabulation unit 5, and the output unit 6 may be implemented by different pieces of hardware.

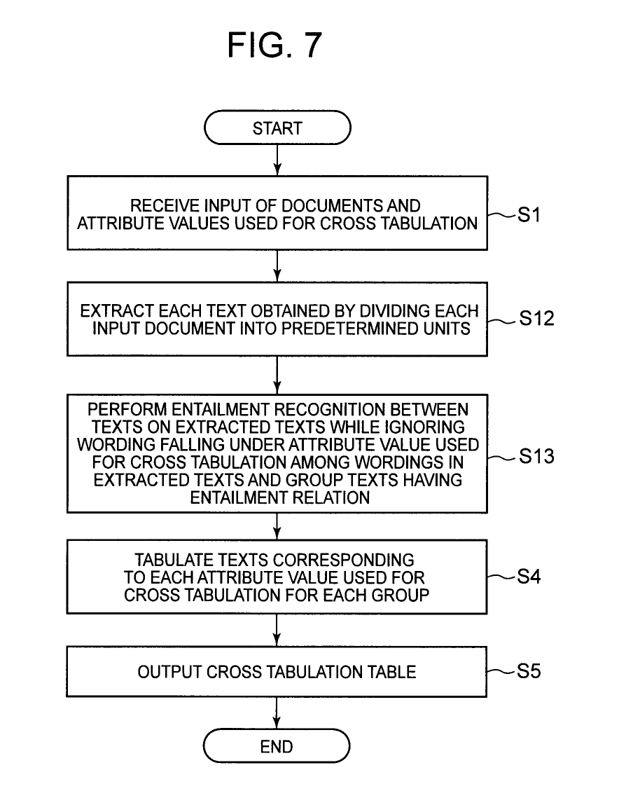

Subsequently, the progress of processing will be described. FIG. 7 is a flowchart illustrating an example of the progress of processing according to the second exemplary embodiment of the present invention. The same reference numerals as those of FIG. 2 are used for the same processes as in the first exemplary embodiment and the description thereof is omitted here. First, the input unit 2 receives inputs of documents and each attribute value used for cross tabulation (each attribute value of an attribute corresponding to one tabulation axis in cross tabulation) (step S1). Each document input in step S1 includes only texts representing a specific content (for example, a customer complaint). Moreover, each document is associated with any one of the attribute values used for cross tabulation and information of the corresponding attribute value is appended to the document.

The text extraction unit 13 extracts each text obtained by dividing each input document into predetermined units (for example, into sentence units) (step S12). In step S12, the text extraction unit 13 associates the extracted text with the same attribute value as one having been associated with the extraction source document.

Each text extracted in step S12 may include an attribute value used for cross tabulation.

Subsequently, the group generation unit 14 ignores a wording falling under the attribute value used for cross tabulation among wordings in the texts extracted in step S12 in performing the entailment recognition between texts on the texts extracted in step S12. Then, the group generation unit 14 generates a group of texts so that the texts having an entailment relation belong to the same group (step S13).

For example, when the wording storage unit 19 illustrated in FIG. 6 is provided and the group generation unit 14 performs entailment recognition between texts in step S13, the group generation unit 14 may perform the entailment recognition while ignoring the wordings stored in the wording storage unit 19 among wordings in the texts. The wording storage unit 19 has already been described and therefore the description thereof will be omitted here.

The group generation unit 14 may perform entailment recognition assuming that the wording stored in the wording storage unit 19 is absent in the wordings in the texts. Alternatively, the group generation unit 14 may replace the wording (attribute value) stored in the wording storage unit 19 among wordings in the texts with an attribute name to perform entailment recognition.

When grouping texts, the group generation unit 14 deletes a phrase including an attribute value from the representative text of the group. Alternatively, the group generation unit 14 may replace an attribute value included in the representative text of the group with an attribute name. In this manner, the exclusion of the attribute value from the representative text of the group prevents the confusion of an operator who refers to the group.

Subsequently, the tabulation unit 5 tabulates texts corresponding to each attribute value used for cross tabulation for each group generated in step S13 (step S4). The output unit 6 then outputs a cross tabulation table representing the tabulation result of step S4 (step S5).

Steps S1, S4, and S5 in the second exemplary embodiment are the same processes as steps S1, S4, and S5 in the first exemplary embodiment.

In the second exemplary embodiment, when performing entailment recognition between texts, the group generation unit 14 ignores the attribute value used for cross tabulation among wordings in the texts to perform entailment recognition between texts. Then, the group generation unit 14 generates a group of texts so that the texts having an entailment relation are included in the same group on the basis of the entailment recognition result. Therefore, there is no dependence relation between an individual group and an attribute value used for cross tabulation. Specifically, similarly to the first exemplary embodiment, one group may include a mix of texts associated with various attribute values. Therefore, also in the second exemplary embodiment, when an attribute corresponding to one tabulation axis is set similarly to the first exemplary embodiment, it is possible to generate a text group which will produce non-obvious tabulation results when cross tabulation is performed using the attribute.

Furthermore, after generating the group, the tabulation unit 5 tabulates texts corresponding to each attribute value used for cross tabulation for each group. Specifically, the cross tabulation is performed. Then, the output unit 6 outputs a cross tabulation table. Therefore, as illustrated in FIG. 3, for example, a significant tabulation result of texts corresponding to each attribute value can be obtained in each group. Furthermore, significant findings can be obtained from the tabulation result.

Also in the second exemplary embodiment, description has been made by giving an example in which preprocessing is performed on each document in advance so that an individual document includes only texts representing a specific content (for example, a customer complaint). The document input in step S1 may be a document for which such preprocessing is not performed. In this case, preferably the text extraction unit 13 extracts only a text falling under a previously-set specific content. For example, when extracting each text obtained by dividing each input document into predetermined units, preferably the text extraction unit 13 extracts the text under the condition that the text includes a wording representing the specific content. When extracting a text representing “a customer complaint,” an operator previously specifies keywords falling under the complaint such as “expensive” or the like. The text extraction unit 13 then extracts a text under the condition that the specified keyword is included in the text. According to this configuration, texts can be grouped for texts falling under the specific content without performing the aforementioned preprocessing.

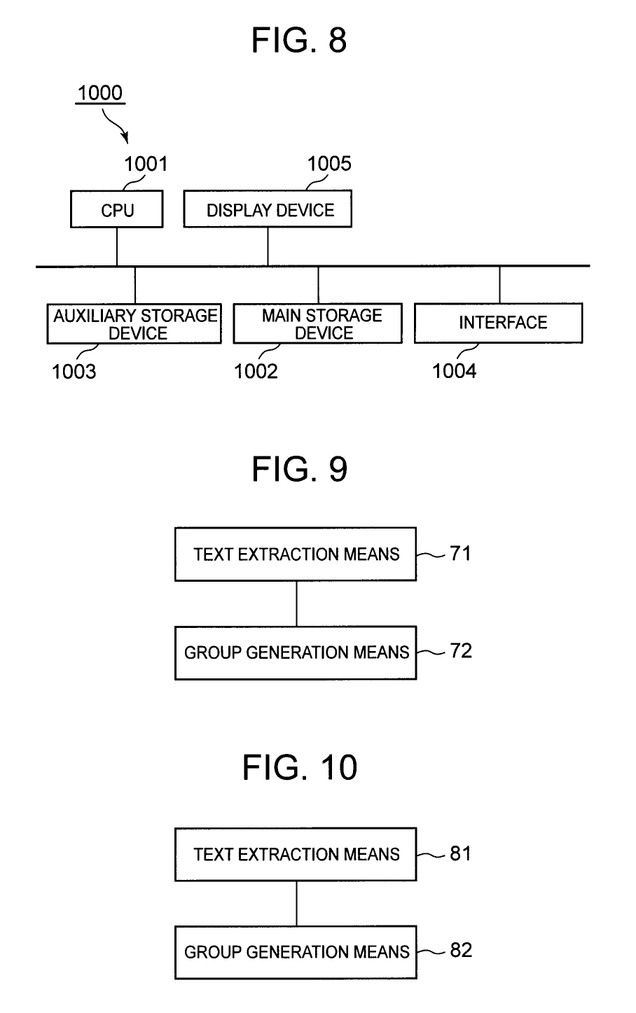

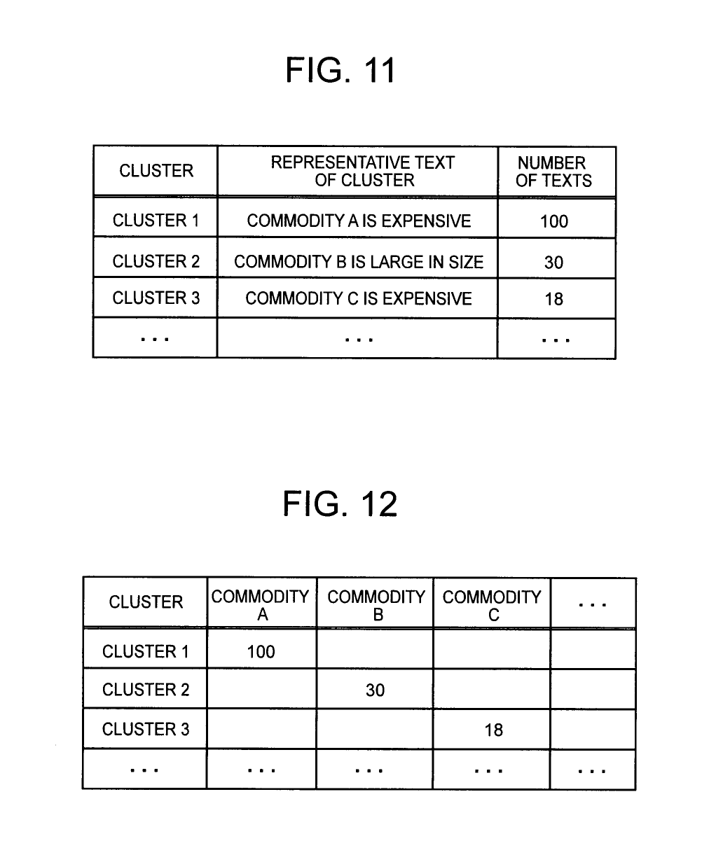

FIG. 8 is a schematic block diagram illustrating a configuration example of a computer according to the respective exemplary embodiments of the present invention. A computer 1000 includes a CPU 1001, a main storage device 1002, an auxiliary storage device 1003, an interface 1004, and a display device 1005.

The above text processing system 1 or 11 is installed in the computer 1000. The operation of the text processing system 1 is stored in the auxiliary storage device 1003 in the form of a program (text processing program). The CPU 1001 reads out the program from the auxiliary storage device 1003, develops the program to the main storage device 1002, and performs the above processing according to the program.

The auxiliary storage device 1003 is an example of a non-transitory tangible medium. As other examples of the non-transitory tangible medium, there are cited a magnetic disk, a magnetic optical disk, a CD-ROM, a DVD-ROM, a semiconductor memory, or the like connected via the interface 1004. Moreover, in the case where the program is distributed to the computer 1000 via communication lines, the computer 1000 which has received the distributed program may develop the program to the main storage device 1002 and perform the above processing.

Furthermore, the program may be for use in implementing a part of the above processing. Moreover, the program may be a differential program for implementing the above processing by a combination with another program already stored in the auxiliary storage device 1003.

Subsequently, the minimum configuration of the present invention will be described. FIG. 9 is a block diagram illustrating an example of the minimum configuration of the text processing system of the present invention. The text processing system of the present invention includes text extraction means 71 and group generation means 72.

At the time of input of respective attribute values of an attribute which corresponds to a tabulation axis in cross tabulation and a document associated with any one of the attribute values of the attribute, the text extraction means 71 (for example, the text extraction unit 3) extracts a portion not including the attribute value of the attribute from each text obtained by dividing the document into predetermined units.

The group generation means 72 (for example, the group generation unit 4) performs entailment recognition between texts on the extracted texts and groups texts having an entailment relation into one group.

The above configuration enables a generation of a text group which will produce non-obvious tabulation results when cross tabulation is performed using an attribute corresponding to one tabulation axis in the case of setting the attribute.

The text extraction means 71 may extract a portion obtained by excluding a phrase including an attribute value of the attribute which corresponds to the tabulation axis in cross tabulation from each text obtained by dividing the input document into predetermined units.

The text extraction means 71 may extract only a part falling under a predicate from each text obtained by dividing the input document into predetermined units.

The present invention may include tabulation means (for example, the tabulation unit 5) for tabulating texts corresponding to the input attribute value for each group.

The text extraction means 71 may extract only a text falling under a predetermined content.

FIG. 10 is a block diagram illustrating another example of the minimum configuration of the text processing system of the present invention. The text processing system of the present invention includes text extraction means 81 and group generation means 82.

At the time of input of respective attribute values of an attribute which corresponds to a tabulation axis in cross tabulation and a document associated with any one of the attribute values of the attribute, the text extraction means 81 (for example, the text extraction unit 13) extracts each text obtained by dividing the document into predetermined units.

The group generation means 82 (for example, the group generation unit 14) performs entailment recognition between texts on the extracted texts while ignoring the attribute value among wordings in the extracted texts and groups texts having an entailment relation.

The above configuration enables a generation of a text group which will produce non-obvious tabulation results when cross tabulation is performed using an attribute corresponding to one tabulation axis in the case of setting the attribute.

The present invention may include wording storage means (for example, the wording storage unit 19) for previously storing each attribute value of the attribute which corresponds to the tabulation axis in cross tabulation as wording to be ignored and the group generation means 82 may ignore the wording stored in the wording storage means among wordings in the extracted text.

The present invention may include tabulation means (for example, the tabulation unit 5) for tabulating a text corresponding to an input attribute value for each group.

The text extraction means 81 may extract only a text corresponding to a predetermined content.

Although the present invention has been described with reference to the exemplary embodiments hereinabove, the present invention is not limited thereto. A variety of changes, which can be understood by those skilled in the art, may be made in the configuration and details of the present invention within the scope thereof.

This application claims priority to Japanese Patent Application No. 2014-149424 filed on Jul. 23, 2014, and the entire disclosure thereof is hereby incorporated herein by reference.

### INDUSTRIAL APPLICABILITY

The present invention is suitably applicable to grouping of texts.

### REFERENCE SIGNS LIST

1, 11 Text processing system

2 Input unit

3, 13 Text extraction unit

4, 14 Group generation unit

5 Tabulation unit

6 Output unit

19 Wording storage unit

1. A text processing system comprising:
a text extraction unit implemented at least by a hardware including a processor and which extracts portions not including attribute values of an attribute from each text obtained by dividing a document into predetermined units at the time of input of respective attribute values of the attribute which corresponds to a tabulation axis in cross tabulation and a document associated with any one of the attribute values of the attribute; and
a group generation unit implemented at least by a hardware including a processor and which performs entailment recognition on the extracted portions and groups portions having an entailment relation.

2. The text processing system according to claim 1, wherein the text extraction unit extracts portions obtained by excluding a phrase including the attribute value of the attribute which corresponds to the tabulation axis in cross tabulation from each text obtained by dividing the input document into predetermined units.

3. The text processing system according to claim 1, wherein the text extraction unit extracts only parts falling under a predicate from each text obtained by dividing the input document into sentence units.

4. The text processing system according to claim 1, further comprising a tabulation unit implemented at least by a hardware including a processor and which tabulates texts corresponding to the input attribute value for each group.

5. The text processing system according to claim 1, wherein the text extraction unit extracts only texts falling under a predetermined content.

6. A text processing system comprising:
a text extraction unit implemented at least by a hardware including a processor and which extracts texts obtained by dividing a document into predetermined units at the time of input of respective attribute values of an attribute which corresponds to a tabulation axis in cross tabulation and a document associated with any one of the attribute values of the attribute; and
a group generation unit implemented at least by a hardware including a processor and which performs entailment recognition between texts on the extracted texts while ignoring the attribute value among wordings in the extracted text and groups texts having an entailment relation.

7. The text processing system according to claim 6, further comprising a wording storage unit implemented by a storage device and which previously stores the respective attribute values of the attribute corresponding to the tabulation axis in cross tabulation as wordings to be ignored, wherein the group generation unit ignores the wordings stored in the wording storage unit among wordings in the extracted text.

8. The text processing system according to claim 6, further comprising a tabulation unit implemented at least by a hardware including a processor and which tabulates texts corresponding to the input attribute value for each group.

9. The text processing system according to claim 6, wherein the text extraction unit extracts only texts corresponding to a predetermined content.

10. A text processing method comprising:
extracting portions not including attribute values of an attribute from each text obtained by dividing a document into predetermined units at the time of input of respective attribute values of the attribute which corresponds to a tabulation axis in cross tabulation and a document associated with any one of the attribute values of the attribute; and
performing entailment recognition on the extracted portions and grouping portions having an entailment relation.

11. (canceled)

12. A non-transitory computer readable recording medium in which a text processing program is recorded, the text processing program causing a computer to perform:
text extraction processing of extracting portions not including attribute values of an attribute from each text obtained by dividing a document into predetermined units at the time of input of respective attribute values of the attribute which corresponds to a tabulation axis in cross tabulation and a document associated with any one of the attribute values of the attribute; and
group generation processing of performing entailment recognition on the extracted portions and grouping portions having an entailment relation.

13. (canceled)
